(19) United States
(12) Patent Application Publication
(10) Pub. No.: US 2022/0192246 A1
(43) Pub. Date: Jun. 23, 2022

(54) COMPOSITION AND METHOD FOR SYNBIOTICS SUPPLEMENT CONTAINING PROBIOTICS, DIGESTIVE ENZYMES, PREBIOTICS, YEAST, PROTEIN, B VITAMINS, AND FLAVORING AGENT

(71) Applicant: Viva Life Science, Inc., Costa Mesa, CA (US)

(72) Inventor: Ping Yang, Fountain Valley, CA (US)

(21) Appl. No.: 17/560,023

(22) Filed: Dec. 22, 2021

Related U.S. Application Data
(60) Provisional application No. 63/129,419, filed on Dec. 22, 2020.

(51) Int. Cl. A23L 33/135; A23L 33/15; A23L 33/185

(52) U.S. Cl. CPC A23L 33/135; A23L 33/15; A23L 33/185; A23Y 2220/03; A23Y 2240/75; A23Y 2220/73; A23Y 2300/25; A23Y 2300/55; A23Y 2300/21; A23Y 2220/15

(57) ABSTRACT

A composition and method for use of a dietary supplement for promoting gastrointestinal health including effective amounts of probiotics, digestive enzymes, prebiotics, a dried, non-viable yeast, protein, B vitamins, and flavoring agent. The multi-strain of probiotics may be viable and dried bacteria like Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus. The multistrain and multispecies probiotics may show synergistic effects. Digestive enzymes can be protease, lactase, cellulose, and/or pancreatin. The prebiotics may be inulin and other dietary fiber. The yeast may be Brewer's or Baker's yeast. The protein may be whey or soy or rice protein concentrates. The B vitamins may be Pantothenic Acid, Thiamine, Riboflavin, Niacinamide, Pyridoxine, Cyanocobalamin, Folic Acid and Biotin. The flavoring agent may be natural vanilla.

### BACKGROUND OF THE INVENTION

Synbiotics is defined as “mixtures of probiotics and prebiotics that beneficially affect the host by improving the survival and implantation of live microbial dietary supplements in the gastrointestinal tract, by selectively stimulating the growth and/or by activating the metabolism of one or a limited number of health-promoting bacteria, thus improving host welfare.” Probiotics are active microorganisms which are colonized within the human intestinal tract, and can produce health benefits to the host. Belonging to the probiotics are mainly some species of the genera Lactobacillus, Bifidobacterium, Streptococcus, Pediococcus, Lactococcus, Propionibacterium, Leuconostoc and, in a lower extent, Saccharomyces, Bacillus and Enterococcus. Some of the popularly used probiotic microorganisms are Lactobacillus rhamnosus, Lactobacillus reuteri, Bifidobacterium bifidum, Bifidobacterium longum, Bifidobacterium animalis subsp. Lactis and certain strains of Lactobacillus casei, Lactobacillus acidophilus-group, Bacillus coagulans, Escherichia coli strain Nissle 1917, certain enterococci, especially Enterococcus faecium SF68, Streptococcus thermophilus and the yeast Saccharomyces boulardii.

Numerous research studies verified that several species of Lactobacilli, Bifidobacteria and Streptococcus are qualified as beneficial microflora and met the criteria such as survival at the site where they are to be active (bile resistant, metabolically active in GI tract, able to adhere to the GI tract), well tolerated by the immune system, possess antimicrobial activity toward pathogenic bacteria, and reduce colon pH. Those species include Lactobacillus acidophilus, Lactobacillus bulgaricus, Lactobacillus rhamnosus, Bifidobacterium bifidum, Bifidobacterium longum, Bifidobacterium, Bifidobacterium animalis subsp. Lactis and Streptococcus thermophilus. Those probiotics have “generally regarded as safe” status.

The health benefits of probiotics are many fold. Micro-organisms associated with health benefits in vivo include many members of Lactobacillus and Bifidobacterium genera, although Escherichia coli, Streptococci, Enterococcus and Lactococci have also been used. Probiotics have antimicrobial properties that can produce inhibitory substances that inhibit growth of pathogens. They can prevent/reduce rotavirus-induced or antibiotic-associated diarrhea and alleviation of complaints due to lactose intolerance. Some prospective probiotics (such as Bifidobacterium longum, Lactobacillus rhamnosus, and Lactobacillus acidophilus) can enhance the immune response of the host. Probiotics carry beneficial effects on microbial aberrancies, inflammation and other complaints in connection with: inflammatory diseases of the gastrointestinal tract, Helicobacter pylori infection or bacterial overgrowth, normalization of passing stool and stool consistency in subjects suffering from constipation or an irritable colon, prevention or alleviation of allergies and atopic diseases in infants, prevention of respiratory tract infections (common cold, influenza) and other infectious diseases, as well as treatment of urogenital infections.

Probiotics have also been found to have anticarcinogenic properties (such as anti-colon cancer effect from combination with Lactobacillus rhamnosus, Bifidobacterium lactis and inulin). Probiotics could reduce the concentration of cancer promoting enzymes and/or putrefactive (bacterial) metabolites in the gut, as well as prevent and alleviate unspecific and irregular complaints of the gastrointestinal tracts in healthy people. Probiotics such as Lactobacillus can enhance short-chain fatty acid production which is one of the essential factors for the beneficial effects exerted by probiotics. Supplementation of the diet with Bifidobacterium spp and Lactobacillus acidophilus show antiatherogenic and cholesterol lowering attributes. More studies have suggested that probiotics-based selective strains of Lactobacilli and Bifidobacteria show beneficial effects on diabetes and obesity.

Digestive enzymes are enzymes that are produced and secreted by the gastrointestinal system to break down fats, proteins, and carbohydrate so that they can be taken up by the organism. The supplementation of digestive enzymes may provide reliable help in clinical practice for management of several digestive diseases. The applications of digestive enzyme supplementation are therapy of choice for the management of exocrine pancreatic insufficiency (EPI), lactose intolerance, celiac disease (CD), gastro-esophageal reflux disorders (GERD), etc. Previous research suggested that the combination of digestive enzymes and probiotics may constitute a new, intriguing, and convenient formulation in the therapy of these diseases (EPI, CD, GERD). It is also important to have tailored probiotics in addition to the enzyme supplement. For example, Lactobacillus bulgaricus and Streptococcus thermophilus play an active role in the hydrolysis of lactose during the fermentation.

A prebiotic is a food or dietary supplement product that allows specific changes, both in the composition and/or activity of probiotics and inhibit the growth of harmful bacteria. Most commonly used prebiotics are fibers like brown seaweed, fructooligosaccharides (FOS), galactooligosaccharides (GOS), xylooligosaccharides (XOS), inulin, and fructans. Recently several plant sources have been explored for their benefits as prebiotics. Some of these novel prebiotics include seaweed, green algae, inulin-type fructans, yacon root, etc. In addition to promoting the activity of probiotics, prebiotics, like inulin and pectin, exhibit several health benefits such as reducing the prevalence and duration of diarrhea, relief from inflammation with intestinal bowel disorders and protective effects to prevent colon cancer, enhancing the bioavailability and uptake of minerals, and lowering of some risk factors of cardiovascular disease and obesity.

B vitamins play a vital role in maintaining good health and well-being. As the building blocks of a healthy body, B vitamins have a direct impact on energy levels, brain function, and cell metabolism. In general, dietary supplements containing all eight (Pantothenic Acid, Thiamine, Riboflavin, Niacinamide, Pyridoxine, Cyanocobalamin, Folic Acid and Biotin) are referred to as a vitamin B complex. Each B vitamin is either a cofactor (generally a coenzyme) for key metabolic processes, or is a precursor needed to make one.^{[9]} The supplementation of all these B-vitamins promoted the growth of lactobacilli and promoted the synthesis of riboflavin and folic acid by lactobacilli.

It has been researched that nutritional supplementation of the human diet by orally administered cultured probiotics, including Lactobacillus acidophilus, Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus preparations have numerous health benefits. Prebiotics (e.g. inulin, oligosaccharide, dietary fiber) can stimulate the growth of endogenous lactic acid bacteria and Bifidobacterium to improve the health of the host. The fermentability and bifidogenic effect of prebiotics have been confirmed with in vitro and in vivo studies.

Well-designed multistrain and multispecies probiotics can benefit from a certain amount of synergism when different probiotics effects of different probiotics strains and species are combined. The activity and efficacy of anti-pathogens also can be stimulated and increased through the symbiosis effect. For example, Streptococcus thermophilus are oxygen scavengers and create anaerobic conditions that could enhance the growth and survival of strict anaerobes like bifidobacteria. It is proven that lactobacillus is the most abundant member of the LAB-genera in the proximal small intestine; Bifidobacterium has a strong preference for the large intestine. The majority of Bifidobacterium bifidum is found in the colon, lower small intestine and breast milk. Bifidobacterium longum is part of the gut flora and its persistence in the gut adds the adhesion to intestinal cells. Lactobacillus acidophilus has a super strong ability to survive in the gastro-acid, bile salt, enzyme digestion pressure condition. Lactobacillus bulgaricus and Streptococcus thermophilus are not natural inhabitants in the human gut, but due to their metabolism can produce beneficial factors to support the GI tract. Lactobacillus bulgaricus and Streptococcus thermophilus work in synergy to produce amino acids, which are then used by Streptococcus thermophilus. Bifidobacterium animalis subsp. Lactis colonizes the human gastrointestinal tract, which represents up to 90% of the bacterial content of an infant's GI tract, but then reduces to 3% with aging. It was reported that a progressive increment of Bifidobacterium animalis growth is enhanced through the presence of Lb. acidophilus, while growth of Lb. acidophilus can also be enhanced by the presence of Bifidobacterium animalis.

Most studies on probiotics utilize single strains and there are fewer studies on the efficacy of mixtures of probiotics strains. Some studies proved that mixtures of probiotics had beneficial effects on the end points, including irritable bowel syndrome and gut function, diarrhea, atopic disease, immune function, respiratory tract infections, gut microbiota modulation, inflammatory bowel disease and treatment of Helicobacter pylori infection. Multistrain probiotics appear to show greater efficacy than single strains. It was studied that probiotics containing multiple strains of Lactobacillus rhamnosus, Lactobacillus acidophilus and Lactobacillus bifidus and multiple species of Bifidobacterium bifidum and Lactobacillus acidophilus may be more effective in preventing dysbiosis induced by ceftreiaxone treatment than other probiotics preparations.

Although there are numerous publications related to formulation and effects of synbiotics with probiotics and prebiotics properties and health benefits, there is no such nutritional synbiotics supplement that contains Lactobacillus acidophilus, Lactobacillus bulgaricus, Lactobacillus rhamnosus, Bifidobacterium bifidum, Bifidobacterium longum, Bifidobacterium animalis subsp. Lactis, Streptococcus thermophilus, yeast, inulin, soy protein and B vitamins.

There is abundant research of biotic products focusing on balanced colonic microflora, but there are few reports investigating intestinal digestive enzyme activities. Clinical and animal experiments indicated that gut-derived endotoxins and imbalanced intestinal microbiota contribute to the pathogenesis of alcoholic liver disease (ALD). Although synbiotics have been used to modulate the gut flora in patients with infectious diarrhea and inflammatory bowel diseases (IBD), there is little evidence from research studies of the relationship between synbiotics and alcoholic liver disease (ALD). However, there is one study that demonstrated that synbiotics possess a novel hepatoprotective function by improving the intestinal permeability and microbota in rats with ethanol-induced liver injury.

### SUMMARY OF THE INVENTION

The present invention comprises a synbiotics composition including probiotics, digestive enzymes, prebiotics, yeast, protein and vitamin B complex. This unique invention provides new compositions, where it is useful in promoting the health and wellbeing of humans and animals, and shelf-life of the probiotics is stable for at least one year upon storage in cool temperature conditions. One research study showed that a synbiotic composition significantly improved the ecosystem of the intestinal tract by increasing the probiotics population and jejuna digestive enzyme activates in rats after taking of a low and high dose of the synbiotics combination. Another research study proved a synbiotics supplementation effectively inhibited the elevation of plasma endotoxin levels during ethanol exposure by means of normalizing the intestinal permeability and fecal microbial composition, which provided ameliorating effects on ethanol-induced liver injuries.

The present invention provides compositions for use in supplementing the mammalian diet comprising dried probiotics, such as Lactobacillus acidophilus, Lactobacillus bulgaricus, Lactobacillus rhamnosus, Bifidobacterium bifidum, Bifidobacterium longum, and Streptococcus thermophilus, and this well-designed multistrain of probiotics are useful for the manufacturing and processing of foods, and dietary food supplementation products.

The present invention provides compositions comprising stable probiotics such as Lactobacillus acidophilus, Lactobacillus bulgaricus, Lactobacillus rhamnosus, Bifidobacterium bifidum, Bifidobacterium longum, and Streptococcus thermophilus cultures that are useful in the preparation of commercially viable food or food supplement products, and that are stable upon storage in an airtight container and cool/refrigerated place.

The present invention provides compositions comprising stable probiotics such as Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus cultures that are useful in the preparation of commercially viable food or food supplement products, and that are stable upon storage in an airtight container and cool/refrigerated place.

The present invention provides compositions comprising probiotics that are combination of 2 to 7 strains selected from Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus cultures that are useful in the preparation of commercially viable food or food supplement products, and that are stable upon storage in an airtight container and cool/refrigerated place.

The present invention provides compositions comprising probiotics with or without the choice of combination from any digestive enzyme, prebiotics such as inulin, yeast such as Brewer's or Baker's yeast, protein such as soy protein and vitamin B complex, that are useful for the manufacturing and processing of foods, and dietary food supplementation products.

The present invention provides compositions for use as a nutritional supplement comprising probiotics, digestive enzyme, prebiotics, yeast, protein and vitamin B complex, to the human diet that is useful in promoting the health and wellbeing of humans and animals.

Finally, the present invention provides methods for stabilizing dried bacterial cultures and synbiotics powder, which can be packed either in powder or capsule form.

### DETAILED DESCRIPTION OF THE INVENTION

The present invention provides a composition for use as a dietary supplement for promoting gastrointestinal health comprising: (1) an effective amount and optimal combination of probiotics, such as Lactobacillus acidophilus, Lactobacillus bulgaricus, Bifidobacterium bifidum, Bifidobacterium longum, Bifidobacterium longum, and Streptococcus thermophilus, with/or without Bifidobacterium animalis subsp. Lactis and Lactobacillus rhamnosus, (2) in combination with digestive enzymes, such as papain, bromelain, lactase, cellulose, and pancreatin, (3) in combination with prebiotics, such as inulin; (4) with an effective amount of a non-living, dried yeast as a source of carbohydrates, vitamins and minerals; in combination with; (5) an effective amount of protein, and (6) an effective amount of vitamin B mix.

All the materials used in the present invention are ordinary commercial products and are commercially available. The bacterial strain may be selected from any strain which satisfies the definition of a probiotics, either animal/dairy or vegan/vegetarian culture medium, and has acceptable shelf-life for the product into which the preparation of the invention is to be incorporated with prebiotics and other ingredients. For example, this dietary supplement is required to remain stable and effective for at least 12 months when the product is stored in an airtight container and cool/refrigerated place. All the bacterial strains were deposited in the International Depository Authority: China Center for Type Culture Collection (CCTCC). Each strain was identified according to the results of the morphological, physiological properties, sequence of 16S rRNA gene and Tuf gene.

The probiotics bacterial strain is preferably Lactobacillus, Bifidobacterium, Streptococcus and Bacillus. Examples of preferred Lactobacillus are Lactobacillus acidophilus, Lactobacillus bulgaricus, Lactobacillus rhamnosus, Lactobacillus paracasei, Lactobacillus reuteri, Lactobacillus casei. Examples of preferred Bifidobacterium are Bifidobacterium bifidum, Bifidobacterium longum, Bifidobacterium animalis subsp. Lactis, Bifidobacterium breve, and Bifidobacterium infantis. Examples of preferred Streptococcus are Streptococcus thermophilus, Streptococcus lactis, Streptococcus cremoris, Streptococcus diacetylactis, Streptococcus faecium, and Streptococcus faecalis. Examples of preferred Bacillus are Bacillus coagulans.

The probiotics used in the present invention have a bacterial density of no less than 10 to 50 billion CFU/g, preferably no less than 15 to 40 billion CFU/g. The Lactobacillus used in the present invention has a bacterial density of no less than 2 to 10 billion CFU/g, preferably no less than 4 billion CFU/g. The Bifidobacterium used in the present invention has a bacterial density of no less than 5 to 40 billion CFU/g, preferably no less than 10 to 20 billion CFU/g. The Streptococcus used in the present invention has a bacterial density of no less than 0.5 to 5 billion CFU/g, preferably no less than 1 billion CFU/g.

The digestive enzymes component of the compositions of the present invention may be selected from protease, lactase, cellulose, amylase and lipase. The most preferred digestive enzymes are papain, bromelain, lactase, cellulose and pancreatin containing protease, amylase and lipase. The amount of the digestive enzymes employed in the present invention is from about 0.5% to about 23% of the total mass, most preferably from about 2% of the total mass of compositions of the present invention.

The prebiotics component of the compositions of the present invention may be selected from the group consisting of FOS, GOS, XOS, inulin, and fructans. By providing a source of nourishment for the probiotics, the prebiotics component prevents bacterial counts from decreasing over time and, hence, aids in the stability of the bacterial culture. The most preferred prebiotics form is chicory inulin. The amount of the prebiotics employed in the present invention is from about 1% to about 14% of the total mass, most preferably from about 3% of the total mass of compositions of the present invention.

The yeast component of the compositions of the present invention may be selected from the group consisting of non-living, dry Brewer's or Baker's yeast (Saccharomyces cerevisiae). Both yeasts are sources of carbohydrates, vitamins and minerals upon which the bacteria may derive nourishment, even in their dried state. The amount of the yeast (Saccharomyces cerevisiae) employed in the present invention is from about 2.5% to about 10%, and most preferably from about 4% to about 8% of the total mass of compositions of the present invention.

The protein source may be chosen from a number of protein sources, consisting of whey protein concentrates, rice protein concentrates, or, most preferably, soy protein isolate. The amount of protein concentrate used in the compositions of the present invention is from about 2% to about 80%, and most preferably to about 75% of the total mass of the compositions of the present invention.

The vitamin B complex may be chosen from a number of vitamin sources well known to the art, which include Pantothenic Acid, Thiamine, Riboflavin, Pyridoxine, Cyanocobalamin, Folic Acid and Biotin, or most preferably Pantothenic Acid, Thiamine, Riboflavin, Niacinamide, Pyridoxine, Cyanocobalamin, Folic Acid and Biotin, and may comprise from about 0.1% to about 0.5% of the total mass, The amount of vitamin B mix concentrate used in the compositions of the present invention is from about 0.1% to about 0.5%, and most preferably from about 0.25% to about 0.45% of the total mass of the compositions of the present invention, or most preferably 1.0 to 5.0 mg of Pantothenic Acid, 0.1 to 1.0 mg of Thiamine, 0.1 to 1.5 mg of Riboflavin, 2.0 to 10 mg of Niacinamide, 0.1 to 2.0 mg of Pyridoxine, 0.5 to 5.0 mcg of Cyanocobalamin, 50 to 300 mcg of Folic Acid and 25 to 200 mcg of Biotin per 7.5 grams of the total mass of the compositions of the present invention.

The flavor agent source may be chosen from, but not limited to, several natural flavors, which include vanilla, banana, orange, chocolate and strawberry flavor, but most preferably vanilla natural flavor. The amount of flavor agent concentrate used in the compositions of the present invention is from about 1% to about 5%, and most preferably from about 2.5% to about 4% of the total mass of the compositions of the present invention.

When admixed, the dried bacteria, digestive enzyme, inulin, yeast, protein and vitamin B components of the compositions of the present invention are in a solid, granular form. This form aids in the manufacturing process in that it tends not to clump or stick to the machinery in which it is admixed. The granular solid is freely divided, free-flowing, dry, and may be easily handled. In addition, this form negates the need for excipients to confer desired physical characteristics such as tableting ability, capsuling ability, compressibility, and the like.

Optionally, excipients such as flavoring agents, flowing agents, anti-caking agents, and other excipients commonly used in pharmaceutical manufacturing processes may be employed in the compositions of the present invention.

To make the compositions of the present invention, all components are blended. Prior to their blending, all components are preferably maintained in sealed containers in which they are protected from atmospheric humidity. The components may be combined and blended in standard commercial scale blenders such as a 100-1000 kg Ribbon blender. The components are blended in the blender for a period of time sufficient to assure intimate admixture of all, such period of time depending on the amount of material to be admixed and the size of the blender.

The compositions of the present invention, when in this stable, granular form, may be diluted preferably in water and then consumed. A proper dosage range of the compositions of the present invention in humans and small animals will depend upon the particular needs of the mammal, and may range from about 0.5 g to about 30.0 g per day, and preferably about 7.5 g per day. In its solid granular form, the compositions of the present invention may be diluted preferably in water and then consumed. A dose of about 7.5 g of the composition of the present invention may be diluted in about 90 ml of water. Alternatively, the compositions of the present invention may be sprinkled onto or admixed with other foods.

The compositions of the present invention, when in the capsule form, may be consumed directly with water or other liquid. A proper dosage range of the compositions of the present invention in humans and small animals will depend upon the particular needs of the mammal, and may range from about 1 capsule to about 6 capsules per day, and preferably about 3 capsules per day. A dose of one capsule of the composition of the present invention may contain 600 to 700 mg of solid granular form. Alternatively, the compositions of the present invention may be sprinkled onto or admixed with other foods.

Also contemplated by the present disclosure are variants of the strains described herein. As used herein, the term “variant” refers to both naturally occurring and specifically developed variants or mutants of the strains disclosed and exemplified herein. Variants may or may not have the same identifying biological characteristics of the specific strains exemplified herein, provided they share similar advantageous properties in terms of their ability to be used as probiotic strains for the treatment or prevention of kidney disease, dysbiotic gut or compositions associated with dysbiotic gut. Illustrative examples of suitable methods for preparing variants of the strains exemplified herein include, but are not limited to, culturing under selective growth conditions, gene integration techniques such as those mediated by insertional elements or transposons or by homologous recombination, other recombinant DNA techniques for modifying, inserting, deleting, activating or silencing genes, intraspecific protoplast fusion, mutagenesis by irradiation with ultraviolet light or X-rays, or by treatment with a chemical mutagen such as nitrosoguanidine, methylmethane sulfonate, nitrogen mustard and the like, and bacteriophage-mediated transduction. Suitable and applicable methods are well known in the art and are described, for example, in J. H. Miller, Experiments in Molecular Genetics, Cold Spring Harbor Laboratory Press, Cold Spring Harbor, N.Y. (1972); J. H. Miller, A Short Course in Bacterial Genetics, Cold Spring Harbor Laboratory Press, Cold Spring Harbor, N.Y. (1992); and J. Sambrook, D. Russell, Molecular Cloning: A Laboratory Manual, 3rd ed., Cold Spring Harbor Laboratory Press, Cold Spring Harbor, N.Y. (2001), inter alia.

Also encompassed by the term “variant” as used herein are microbial strains phylogenetically closely related to strains disclosed herein and strains possessing substantial sequence identity with the strains disclosed herein at one or more phylogenetically informative markers such as rRNA genes, elongation and initiation factor genes, RNA polymerase subunit genes, DNA gyrase genes, heat shock protein genes and recA genes. For example, the 16S rRNA genes of a “variant” strain as contemplated herein may share about 85%, 86%, 87%, 88%, 89%, 90%, 91%, 92%, 93%, 94%, 95%, 96%, 97%, 98% or 99% sequence identity with a strain disclosed herein.

The bacterial strains to be employed in accordance with the present disclosure may be cultured according to any suitable method known to the skilled addressee and may be prepared for addition to a composition by, for example, freeze-drying, spray-drying or lyophilisation. Thus, in embodiments of the present disclosure the bacterial strains may be in a dried form (such as lyophilized or sporulated form) in a suitable carrier medium, for example a FOS medium or other soluble fiber, sugar, nutrient or base material for the composition, with which the bacterial strains can be presented in an orally administrable form. One or more of the strains may be encapsulated in, for example, a suitable polymeric matrix to improve long term stability and storage of the compositions. In one example, encapsulation may comprise alginate beads, although those skilled in the art will appreciate that any suitable encapsulation material or matrix may be used. Encapsulation may be achieved using methods and techniques known to those skilled in the art.

The invention will now be illustrated by reference to the following examples.

### Example 1

To keep the stability of probiotics, the dry powder of probiotics blend is stored in a temperature controlled 4 to 10 C.° storage room. To determine if probiotics meet the specifications of the present invention, the viability and total account of Lactobacillus acidophilus, Lactobacillus bulgaricus and Lactobacillus rhamnosus are analyzed by enumeration at APT agar aerobically (37 C°, 72 hours), Bifidobacterium bifidum, Bifidobacterium longum, and Bifidobacterium animalis subsp. Lactis are analyzed by enumeration at MRS agar anaerobically (37 C°, 72 hours), and Streptococcus thermophilus is analyzed by enumeration at M17 agar aerobically (37 C°, 48 hours).

### Example 2

In Mix A contains ingredients of probiotics with total viability no less than 15 billion cfu/g of (4 billion cfu/g of Lactobacillus acidophilus and Lactobacillus bulgaricus, 6 billion cfu/g of Bifidobacterium bifidum, Bifidobacterium longum and Bifidobacterium animalis subsp. Lactis and 1 billion cfu/g of Streptococcus thermophilus) 40 kg, papain (70 MCU/g) 2.55 kg, bromelain (600 MCU/g) 1.49 kg, lactase (5000 ALU/g) 2.38 kg, chicory inulin 14 kg, Soy Protein Isolate (90%) 315.5 kg, Brewer's dried basic yeast (Saccharomyces cerevisiae) 34 kg, and Vanilla French 2× Natural Flavor 14 kg. Mix A was combined and screened through a #14 mesh screen, and charge the screened material into a blender, and mixed for 5 minutes.

Mix B contains ingredients of vitamin B mix (2.5 mg of Pantothenic Acid, 0.375 mg of Thiamine, 0.425 mg of Riboflavin, 5 mg of Niacinamide, 0.5 mg of Pyridoxine, 1.5 mcg of Cyanocobalamin, 100 mcg of Folic Acid and 75 mcg of Biotin per 7.5 grams of the total mass of the compositions of the present invention) 1.063 kg. Mix B was combined in a double lined poly-bag, sealed and Bag Blended for 5 minutes. Then screen the material through a #20 mesh screen.

Mix A and Mix B were combined into a blender and blended for 10 minutes, then packaged into a double lined poly-bag, which is then sealed such that they are airtight.

### Example 3

Mix A contains ingredients of probiotics with total viability no less than 15 billion cfu/g of (4 billion cfu/g of Lactobacillus acidophilus, Lactobacillus bulgaricus, and Lactobacillus rhamnosus, 6 billion cfu/g of Bifidobacterium bifidum, Bifidobacterium longum and Bifidobacterium animalis subsp. Lactis and 1 billion cfu/g of Streptococcus thermophilus) 40 kg, papain (70 MCU/g) 2.55 kg, bromelain (600 MCU/g) 1.49 kg, lactase (5000 ALU/g) 2.38 kg, cellulose (500 CU/g) 2.38 kg, pancreatin (4× Fungal) 1.19 kg, chicory inulin 14 kg, Soy Protein Isolate (90%) 312.6 kg, Brewer's dried basic yeast (Saccharomyces cerevisiae) 34 kg, and Vanilla French 2× Natural Flavor 14 kg. Mix A was combined and screened through a #14 mesh screen, and charge the screened material into a blender, and mixed for 5 minutes.

Mix B contains ingredients of vitamin B mix (2.5 mg of Pantothenic Acid, 0.375 mg of Thiamine, 0.425 mg of Riboflavin, 5 mg of Niacinamide, 0.5 mg of Pyridoxine, 1.5 mcg of Cyanocobalamin, 100 mcg of Folic Acid and 75 mcg of Biotin per 7.5 grams of the total mass of the compositions of the present invention) 1 kg. Mix B was combined in a double lined poly-bag, sealed and Bag Blended for 5 minutes. Then screen the material through a #20 mesh screen.

Mix A and Mix B were combined into a blender and blended for 10 minutes, then packaged into a double lined poly-bag, which is then sealed such that they are airtight.

### Example 4

Mix A contains ingredients of probiotics with total viability no less than 15 billion cfu/g (Lactobacillus acidophilus 3.5 billion cfu/g and Lactobacillus bulgaricus 0.5 billion cfu/g, Bifidobacterium bifidum 6 billion cfu/g, Bifidobacterium longum 4 billion cfu/g, and Streptococcus thermophilus 1 billion cfu/g) 40 kg, with or without papain (70 MCU/g) 2.55 kg, chicory inulin 14 kg, Soy Protein Isolate (90%) 320 kg, Brewer's dried basic yeast (Saccharomyces cerevisiae) 34 kg, and Vanilla French 2× Natural Flavor 14 kg. Mix A was combined and screened through a #14 mesh serene, and charge the screened material into a blender, and mixed for 5 minutes.

Mix B contains ingredients of vitamin B mix (2.5 mg of Pantothenic Acid, 0.375 mg of Thiamine, 0.425 mg of Riboflavin, 5 mg of Niacinamide, 0.5 mg of Pyridoxine, 1.5 mcg of Cyanocobalamin, 100 mcg of Folic Acid and 75 mcg of Biotin per 7.5 grams of the total mass of the compositions of the present invention) 1 kg. Mix B was combined in a double lined poly-bag, sealed and Bag Blended for 5 minutes. Then screen the material through a #20 mesh screen.

Mix A and Mix B were combined into a blender and blended for 10 minutes, then packaged into a double lined poly-bag, which is then sealed such that they are airtight.

### Example 5

Mix A contains ingredients of probiotics with total viability no less than 40 billion cfu/g (Bifidobacterium animalis subsp. Lactis 20 billion cfu/g, and Bifidobacterium longum 20 billion cfu/g) 15 kg, with or without papain (70 MCU/g) 2.25 kg, chicory inulin 12.5 kg, Soy Protein Isolate (90%) 300 kg, Brewer's dried basic yeast (Saccharomyces cerevisiae) 30 kg, and Vanilla French 2× Natural Flavor 15 kg. Mix A was combined and screened through a #14 mesh screen, and charge the screened material into a blender, and mixed for 5 minutes.

Mix B contains ingredients of vitamin B mix (2.5 mg of Pantothenic Acid, 0.375 mg of Thiamine, 0.425 mg of Riboflavin, 5 mg of Niacinamide, 0.5 mg of Pyridoxine, 1.5 mcg of Cyanocobalamin, 100 mcg of Folic Acid and 75 mcg of Biotin per 7.5 grams of the total mass of the compositions of the present invention) 0.938 kg. Mix B was combined in a double lined poly-bag, sealed and Bag Blended for 5 minutes. Then screen the material through a #20 mesh screen.

Mix A and Mix B were combined into a blender and blended for 10 minutes, then packaged into a double lined poly-bag, which is then sealed such that they are airtight.

### Example 6

Mix A contains ingredients of probiotics with total viability no less than 15 billion cfu/g of (4 billion cfu/g of Lactobacillus acidophilus and Lactobacillus bulgaricus, 6 billion cfu/g of Bifidobacterium bifidum and Bifidobacterium longum, and 1 billion cfu/g of Streptococcus thermophilus) 66.67 kg, chicory inulin 13.45 kg. Mix A was combined and screened through a #14 mesh screen, and charge the screened material into a blender, and mixed for 5 minutes.

Mix B contains ingredients of digestive enzymes [papain (70 MCU/g) 7.5 kg, bromelain (600 MCU/g) 4.38 kg, lactase (5000 ALU/g) 7.0 kg, and magnesium stearate 1.0 kg. Mix B was combined in a double lined poly-bag, sealed and Bag Blended for 5 minutes. Then screen the material through a #20 mesh screen.

Mix A and Mix B were combined into a blender and blended for 10 minutes, then packaged into a double lined poly-bag, which is then sealed such that they are airtight.

The final mix powder was encapsulated into hard shell capsules containing 600-700 mg mixed powder per capsule.

### Example 7

Mix A contains ingredients of probiotics with total viability no less than 15 billion cfu/g of (4 billion cfu/g of Lactobacillus acidophilus and Lactobacillus bulgaricus, and Lactobacillus rhamnosus, 6 billion cfu/g of Bifidobacterium bifidum and Bifidobacterium longum, and Bifidobacterium animalis subsp. Lactis, and 1 billion cfu/g of Streptococcus thermophilus) 57.14 kg, chicory inulin 9.1 kg, Soy Protein Isolate (90%) 2 kg and Brewer's dried basic yeast (Saccharomyces cerevisiae) 4.46 kg. Mix A was combined and screened through a #14 mesh screen, and charge the screened material into a blender, and mixed for 5 minutes.

Mix B contains ingredients of digestive enzymes [papain (70 MCU/g) 6.43 kg, bromelain (600 MCU/g) 3.76 kg, lactase (5000 ALU/g) 6.0 kg, cellulose (500 CU/g) 3.0 kg, pancreatin (4× Fungal) 4.43 kg], and magnesium stearate 1.0 kg, and vitamin B mix (2.5 mg of Pantothenic Acid, 0.375 mg of Thiamine, 0.425 mg of Riboflavin, 5 mg of Niacinamide, 0.5 mg of Pyridoxine, 1.5 mcg of Cyanocobalamin, 100 mcg of Folic Acid and 75 mcg of Biotin per 0.70 grams of the total mass of the compositions of the present invention) 2.68 kg. Mix B was combined in a double lined poly-bag, sealed and Bag Blended for 5 minutes. Then screen the material through a #20 mesh screen.

Mix A and Mix B were combined into a blender and blended for 10 minutes, then packaged into a double lined poly-bag, which is then sealed such that they are airtight.

The final mix powder was encapsulated into hard shell capsules containing 700 mg mix powder per capsule. The nutrition-supplementing amount of the stable, dried synbiotics composition is in the range of about 0.5 grams per day to about 30.0 grams per day if in solid granular form or in the range of about 1 capsule to about 6 capsules per day if in capsulated form. A dose of one capsule of the composition of the present invention may contain 600 to 700 mg of dried synbiotics composition.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

Other compositions, formulations or features and advantages of the subject matter described herein will be or will become apparent to one with skill in the art upon examination of the following figures and detailed description. It is intended that all such additional features and advantages be included within this description, be within the scope of the subject matter described herein, and be protected by the accompanying claims. In no way should the features of the example embodiments be construed as limiting the appended claims, absent express recitation of those features in the claims.

1. A method of formulating a nutrition-supplementing amount of a stable, dried probiotics composition comprising combining as a % total mass of a total dried bacteria composition:
approximately 10 percent total mass solid, dried, viable Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus, from 7 bacterial strains with density of no less than 10 to 50 billion CFU/g.
approximately 2.2 percent total mass solid, digestive enzymes,
approximately 3 percent total mass solid, prebiotics inulin,
approximately 8 percent total mass dried, non-living yeast,
approximately 73 percent total mass soy protein isolate;
approximately 0.25 percent total mass B vitamins; and
approximately 3 percent total mass flavoring agent.

2. A method formulating a nutrition-supplementing amount of a stable, dried probiotics composition comprising combining as % total mass of the total dried bacteria composition:
approximately 9.3 percent total mass solid, dried, viable Lactobacillus acidophilus, Lactobacillus bulgaricus, Bifidobacterium bifidum, Bifidobacterium longum, Bifidobacterium animalis subsp. Lactis and Streptococcus thermophilus, from 6 bacterial strains with density of no less than 10 to 50 billion CFU/g.
approximately 1.5 percent total mass solid, digestive enzymes,
approximately 3 percent total mass solid, prebiotics inulin,
approximately 8 percent total mass dried, non-living yeast,
approximately 75 percent total mass soy protein isolate;
approximately 0.25 percent total mass B vitamins; and
approximately 3 percent total mass flavoring agent.

3. A method or formulating a nutrition-supplementing amount of a stable, dried probiotics composition comprising combining as % total mass of the total dried bacteria composition:
approximately 9.3 percent total mass solid, dried, viable Lactobacillus acidophilus, Lactobacillus bulgaricus, Bifidobacterium bifidum, Bifidobacterium longum, and Streptococcus thermophilus from 5 bacterial strains with density of no less than 10 to 50 billion CFU/g.
approximately 0.6 percent total mass solid, digestive enzymes (optional),
approximately 3 percent total mass solid, prebiotics inulin,
approximately 8 percent total mass dried, non-living yeast,
approximately 75 percent total mass soy protein isolate;
approximately 0.25 percent total mass B vitamins; and
approximately 3 percent total mass flavoring agent.

4. A method of formulating a nutrition-supplementing amount of a stable, dried probiotics composition comprising combining as % total mass of the total dried bacteria composition:
approximately 3 to 10 percent total mass solid, dried, viable Bifidobacterium animalis subsp. Lactis, and Bifidobacterium longum, from 2 bacterial strains with density of no less than 10 to 50 billion CFU/g.
approximately 0.6-2.5 percent total mass solid, digestive enzymes (optional),
approximately 1-5 percent total mass solid, prebiotics inulin,
approximately 5-10 percent total mass dried, non-living yeast,
approximately 20-75 percent total mass soy protein isolate;
approximately 0.15-0.35 percent total mass B vitamins; and
approximately 1 to 3 percent total mass flavoring agent.

5. A method claim 1 wherein the nutrition-supplementing amount of a stable, dried synbiotics composition comprising, as % total mass of the total dried composition:
approximately 4-40 percent total mass solid, probiotics are combination from any following 2 to 7 dried, viable bacterial strains including Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus with density of no less than 10 to 50 billion CFU/g, with or without:
approximately 0.3-2.5 percent total mass solid, digestive enzymes,
approximately 1-5 percent total mass solid, prebiotics inulin,
approximately 5-10 percent total mass dried, non-living yeast,
approximately 20-75 percent total mass soy protein isolate;
approximately 0.15-0.35 percent total mass B vitamins; and
approximately 1 to 3 percent total mass flavoring agent, wherein the viability of the bacteria in the composition is maintained for a period of twelve months when the composition is stored in an airtight container and cool/refrigerated place.

6. A method of formulating a nutrition-supplementing amount of a stable, dried probiotics composition comprising combining as % total mass of the total dried bacteria composition;
approximately 50-67 percent total mass solid, probiotics are combination of any following dried, viable Lactobacillus acidophilus, Lactobacillus bulgaricus, Bifidobacterium bifidum, Bifidobacterium longum, and Streptococcus thermophilus from 5 bacterial strains with density of no less than 10 to 50 billion CFU/g.
approximately 10-19 percent total mass solid, digestive enzymes,
approximately 10-14 percent total mass solid, prebiotics inulin, wherein the viability of the bacteria in the composition is maintained for a period of twelve months when the composition is encapsulated and stored in an airtight container and cool/refrigerated place.

7. A method of formulating a nutrition-supplementing amount of a stable, dried probiotics composition comprising as % total mass of the total dried bacteria composition:
approximately 40-57 percent total mass solid: probiotics are combination of any following dried, viable Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus from 7 bacterial strains with density of no less than 10 to 50 billion CFU/g.
approximately 15-23 percent total mass solid, digestive enzymes,
approximately 5-9 percent total mass solid, prebiotics inulin,
approximately 3-5 percent total mass dried, non-living yeast,
approximately 1-2 percent total mass soy protein isolate;
approximately 1-3 percent total mass B vitamins; and
approximately 0.5 to 1 percent total mass magnesium stearate, wherein the viability of the bacteria in the composition is maintained for a period of twelve months when the composition is encapsulated and stored in an airtight container and cool/refrigerated place.

8. The method claim 1 wherein the nutrition-supplementing amount of the stable, dried synbiotics composition is in the range of about 0.5 grams per day to about 30.0 grams per day if in solid granular form or in the range of about 1 capsule to about 6 capsules per day if in capsulated form.

9. A composition for improving the health of a mammal comprising:
a nutrition-supplementing amount of a stable, dried probiotics composition comprising, as % total mass of the total dried bacteria composition:
approximately 10 percent total mass solid, dried, viable Lactobacillus acidophilus. Lactobacillus bulgaricus, Lactobacillus rhamnosus, Bifidobacterium bifidum, Bifidobacterium longum, Bifidobacterium animalis subsp. Lactis and Streptococcus thermophilus, from 7 bacterial strains with density of no less than 10 to 50 billion CFU/g.
approximately 2.2 percent total mass solid, digestive enzymes,
approximately 3 percent total mass solid, prebiotics inulin,
approximately 8 percent total mass dried, non-living yeast,
approximately 73 percent total mass soy protein isolate;
approximately 0.25 percent total mass B vitamins; and
approximately 3 percent total mass flavoring agent.

10. A composition for improving the health of a mammal comprising:
a nutrition-supplementing amount of a stable, dried probiotics composition comprising, as % total mass of the total dried bacteria composition:
approximately 9.3 percent total mass solid, dried, viable Lactobacillus acidophilus, Lactobacillus bulgaricus, Bifidobacterium bifidum, Bifidobacterium longum, Bifidobacterium animalis subsp. Lactis and Streptococcus thermophilus, from 6 bacterial strains with density of no less than 10 to 50 billion CFU/g.
approximately 1.5 percent total mass solid, digestive enzymes,
approximately 3 percent total mass solid, prebiotics inulin,
approximately 8 percent total mass dried, non-living yeast,
approximately 75 percent total mass soy protein isolate;
approximately 0.25 percent total mass B vitamins; and
approximately 3 percent total mass flavoring agent.

11. The composition of claim 10 wherein the % total mass of the total dried bacteria composition is approximately 9.3 percent total mass solid, dried, viable Lactobacillus acidophilus, Lactobacillus bulgaricus, Bifidobacterium bifidum, Bifidobacterium longum, and Streptococcus thermophilus, from 5 bacterial strains with density of no less than 10 to 50 billion CFU/g:
approximately 0.6 percent total mass solid, digestive enzymes (optional),
approximately 3 percent total mass solid, prebiotics inulin,
approximately 8 percent total mass dried, non-living yeast,
approximately 75 percent total mass soy protein isolate;
approximately 0.25 percent total mass B vitamins; and
approximately 3 percent total mass flavoring agent.

12. The composition of claim 10; wherein the % total mass of the total dried bacteria composition:
approximately 3 to 10 percent total mass solid, dried, viable Bifidobacterium animalis subsp. Lactis, and Bifidobacterium longum, from 2 bacterial strains with density of no less than 10 to 50 billion CFU/g.
approximately 0.6-2.5 percent total mass solid, digestive enzymes (optional),
approximately 1-5 percent total mass solid, prebiotics inulin,
approximately 5-10 percent total mass dried; non-living yeast,
approximately 20-75 percent total mass soy protein isolate;
approximately 0.15-0.35 percent total mass B vitamins; and
approximately 1 to 3 percent total mass flavoring agent.

13. The composition of claim 10, wherein the % total mass of the total dried composition:
approximately 4-40 percent total mass solid, probiotics are combination from any following 2 to 7 dried, viable bacterial strains including Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus with density of no less than 10 to 50 billion CFU/g, with or without:
approximately 0.3-2.5 percent total mass solid, digestive enzymes,
approximately 1-5 percent total mass solid, prebiotics inulin,
approximately 5-10 percent total mass dried: non-living yeast,
approximately 20-75 percent total mass soy protein isolate;
approximately 0.15-0.35 percent total mass B vitamins; and
approximately 1 to 3 percent total mass flavoring agent, and combinations thereof. Wherein the viability of the bacteria in the composition is maintained for a period of twelve months when the composition is stored in an airtight container and cool/refrigerated place.

14. The composition claim 10, wherein the % total mass of the total dried bacteria composition:
approximately 50-67 percent total mass solid, probiotics are combination of any following dried, viable Lactobacillus acidophilus, Lactobacillus bulgaricus, Bifidobacterium bifidum, Bifidobacterium longum, and Streptococcus thermophilus from 5 bacterial strains with density of no less than 10 to 50 billion CFU/g.
approximately 10-19 percent total mass solid, digestive enzymes,
approximately 10-14 percent total mass solid, prebiotics inulin, and combinations thereof, wherein the viability of the bacteria in the composition is maintained for a period of twelve months when the composition is encapsulated and stored in an airtight container and cool/refrigerated place.

15. A composition for improving the health of a mammal comprising as % total mass of the total dried bacteria composition:
approximately 40-57 percent total mass solid, probiotics are combination of any following dried, viable Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus from 7 bacterial strains with density of no less than 10 to 50 billion CFU/g.
approximately 15-23 percent total mass solid, digestive enzymes,
approximately 5-9 percent total mass solid, prebiotics inulin,
approximately 3-5 percent total mass dried, non-living yeast,
approximately 1-2 percent total mass soy protein isolate;
approximately 1-3 percent total mass B vitamins; and
approximately 0.5 to 1 percent total mass magnesium stearate.
wherein the viability of the bacteria in the composition is maintained for a period of twelve months when the composition is encapsulated and stored in an airtight container and cool/refrigerated place.

16. A method of improving the health of a mammal comprising orally administering to the mammal a nutrition-supplementing amount of a stable, dried probiotics composition comprising, as % total mass of the total dried bacteria composition:
approximately 10 percent total mass solid, dried, viable Lactobacillus acidophilus, Lactobacillus bulgaricus, Lactobacillus rhamnosus, Bifidobacterium bifidum, Bifidobacterium longum, Bifidobacterium animalis subsp. Lactis and Streptococcus thermophilus, from 7 bacterial strains with density of no less than 10 to 50 billion CF/g.
approximately 2.2 percent total mass solid, digestive enzymes,
approximately 3 percent total mass solid, prebiotics inulin,
approximately $ percent total mass dried, non-living yeast,
approximately 73 percent total mass soy protein isolate;
approximately 0.25 percent total mass B vitamins; and
approximately 3 percent total mass flavoring agent.

17. A method of improving the health of a mammal comprising orally administering to the mammal a nutrition-supplementing amount of a stable, dried probiotics composition comprising, as % total mass of the total dried bacteria composition:
approximately 9.3 percent total mass solid, dried, viable Lactobacillus acidophilus, Lactobacillus bulgaricus, Bifidobacterium bifidum, Bifidobacterium longum, Bifidobacterium animalis subsp. Lactis and Streptococcus thermophilus, from 6 bacterial strains with density of no less than 10 to 50 billion CFU/g.
approximately 1.5 percent total mass solid, digestive enzymes,
approximately 3 percent total mass solid, prebiotics inulin,
approximately 8 percent total mass dried, non-living yeast,
approximately 75 percent total mass soy protein isolate;
approximately 025 percent total mass B vitamins; and
approximately 3 percent total mass flavoring agent.

18. A method of improving the health of a mammal comprising orally administering to the mammal a nutrition-supplementing amount of a stable, dried probiotics composition comprising, as % total mass of the total dried bacteria composition:
approximately 9.3 percent total mass solid, dried, viable Lactobacillus acidophilus, Lactobacillus bulgaricus, Bifidobacterium bifidum, Bifidobacterium longum, and Streptococcus thermophilus, from 5 bacterial strains with density of no less than 10 to 50 billion CFU/g.
approximately 0.6 percent total mass solid, digestive enzymes (optional),
approximately 3 percent total mass solid, prebiotics inulin,
approximately 8 percent total mass dried, non-living yeast,
approximately 75 percent total mass soy protein isolate;
approximately 0.25 percent total mass B vitamins; and
approximately 3 percent total mass flavoring agent.

19. A method of improving the health of a mammal comprising orally administering to the mammal a nutrition-supplementing amount of a stable, dried probiotics composition comprising, as % total mass of the total dried bacteria composition:
approximately 3 to 10 percent total mass solid, dried, viable Bifidobacterium animalis subsp. Lactis, and Bifidobacterium longum, from 2 bacterial strains with density of no less than 10 to 50 billion CFU/g.
approximately 0.8-2.5 percent total mass solid, digestive enzymes (optional),
approximately 1-5 percent total mass solid, prebiotics inulin,
approximately 5-10 percent total mass dried, non-living yeast,
approximately 20-75 percent total mass soy protein isolate;
approximately 0.15-0.35 percent total mass B vitamins; and
approximately 1 to 3 percent total mass flavoring agent.

20. A method claim 16 wherein the nutrition-supplementing of health benefits amount of a stable, dried synbiotics composition comprising, as % total mass of the total dried composition:
approximately 4-40 percent total mass solid, probiotics are combination from any following 2 to 7 dried, viable bacterial strains including Lactobacillus acidophilus, Lactobacillus bulgaricus Lactobacillus rhamnosus, Bifidobacterium bifidum, Bifidobacterium longum, Bifidobacterium animalis subsp. Lactis and Streptococcus thermophilus with density of no less than 10 to 50 billion CFU/g, with or without:
approximately 0.3-2.5 percent total mass solid, digestive enzymes,
approximately 1-5 percent total mass solid, prebiotics inulin,
approximately 5-10 percent total mass dried, non-living yeast,
approximately 20-75 percent total mass soy protein isolate;
approximately 0.15-0.35 percent total mass B vitamins; and
approximately 1 to 3 percent total mass flavoring agent, wherein the viability of the bacteria in the composition is maintained for a period of twelve months when the composition is stored in an airtight container and cool/refrigerated place.

21. A method of improving the health of a mammal comprising orally administering to the mammal a nutrition-supplementing amount of a stable, dried probiotics composition comprising, as % total mass of the total dried bacteria composition:
approximately 50-67 percent total mass solid, probiotics are combination of any following dried, viable Lactobacillus acidophilus, Lactobacillus bulgaricus, Bifidobacterium bifidum, Bifidobacterium longum, and Streptococcus thermophilus from 5 bacterial strains with density of no less than 10 to 50 billion CFU/g.
approximately 10-19 percent total mass solid, digestive enzymes,
approximately 10-14 percent total mass sold, prebiotics inulin, wherein the viability of the bacteria in the composition is maintained for a period of twelve months when the composition is encapsulated and stored in an airtight container and cool/refrigerated place.

22. A method of improving the health of a mammal comprising orally administering to the mammal a nutrition-supplementing amount of a stable, dried probiotics composition comprising, as % total mass of the total dried bacteria composition:
approximately 40-57 percent total mass solid, probiotics are combination of any following dried, viable Lactobacillus acidophilus, Lactobacillus bulgaricus, Lactobacillus rhamnosus, Bifidobacterium bifidum, Bifidobacterium longum, Bifidobacterium animals subsp. Lactis and Streptococcus thermophilus from 7 bacterial strains with density of no less than 10 to 50 billion CFU/g.
approximately 15-23 percent total mass solid, digestive enzymes,
approximately 5-9 percent total mass solid, prebiotics inulin,
approximately 3-5 percent total mass dried, non-living yeast,
approximately 1-2 percent total mass soy protein isolate;
approximately 1-3 percent total mass B vitamins; and
approximately 0.5 to 1 percent total mass magnesium stearate, wherein the viability of the bacteria in the composition is maintained for a period of twelve months when the composition is encapsulated and stored in an airtight container and cool/refrigerated place.

23. The method claim 16 wherein the nutrition-supplementing amount of the stable, dried synbiotics composition is in the range of about 0.5 grams per day to about 30.0 grams per day if in solid granular form or in the range of about 1 capsule to about 6 capsules per day in capsulated form.
